(19) United States
(12) Patent Application Publication
(10) Pub. No.: US 2014/0140111 A1
(43) Pub. Date: May 22, 2014

(54) REACTOR, CONVERTER AND POWER CONVERSION DEVICE

(71) Applicants: Kazuhiro Inaba, Osaka-shi (JP); Masayuki Kato, Osaka-shi (JP); Hajime Kawaguchi, Osaka-shi (JP); Shinichiro Yamamoto, Osaka-shi (JP)

(72) Inventors: Kazuhiro Inaba, Osaka-shi (JP); Masayuki Kato, Osaka-shi (JP); Hajime Kawaguchi, Osaka-shi (JP); Shinichiro Yamamoto, Osaka-shi (JP)

(73) Assignee: Sumitomo Electric Industries, Ltd., Osaka-shi (JP)

(21) Appl. No.: 14/129,074

(22) PCT Filed: Jun. 21, 2012
(86) PCT No.: PCT/JP2012/065798

§ 371 Date: Dec. 23, 2013

(30) Foreign Application Priority Data
Jul. 4, 2011 (JP) 2011-148683
May 9, 2012 (JP) 2012-107755

(51) Int. Cl. H01F 27/08; H02M 5/458; H02M 7/537

(52) U.S. Cl. CPC H01F 27/085; H02M 7/537; H02M 5/458
USPC 363/37; 363/131; 336/61

(57) ABSTRACT

A reactor includes a coil formed by winding a wire, and a magnetic core in which a closed magnetic path is formed by both an inner core portion inserted in the coil and an outer core portion covering outer peripheral surfaces of the inner core portion and the coil. The outer core portion is formed of a mixture containing a magnetic material and resin. One of the coil and the inner core portion has an exposed portion where a part of the outer peripheral surface is not covered with the outer core portion, and at least a part of the exposed portion is in contact with a heat dissipation layer provided in a heat dissipation plate.

### TECHNICAL FIELD

The present invention relates to a reactor used for, for example, a component of a power conversion device such as a vehicle-mounted DC-DC converter, a converter including the reactor, and a power conversion device including the converter. More particularly, the present invention relates to a reactor having high heat dissipation performance.

### BACKGROUND ART

A reactor is a component of a circuit that increases and decreases the voltage. Patent Literature (PTL) 1 discloses a reactor including a coil, and a magnetic core in which a closed magnetic path is formed by both an inner core portion inserted in the coil and a couple core portion covering at least a part of an outer periphery of the of the inner core portion and the coil. The couple core portion is entirely formed of a mixture (hardened molded body) containing a magnetic material and resin, and is joined to the inner core portion with the contained resin with no adhesive being disposed therebetween. When the reactor is stored in a case, the couple core portion covers substantially all of end faces and an outer peripheral surface of the coil and portions of end faces and an outer peripheral surface of the inner core portion that are not in contact with the case (FIG. 1(A) of PTL 1). When the reactor is not stored in the case, the couple core portion covers the entire outer periphery of the coil and end faces of the coil and end faces of the inner core portion (FIG. 4 of PTL 1).

### CITATION LIST

### Patent Literature

PTL 1: International Publication No. 2011/013394

### SUMMARY OF INVENTION

### Technical Problem

During operation of the reactor, the coil and the magnetic core generate heat when electricity is supplied thereto, and the temperatures of the coil and the magnetic core become high. In particular, a vehicle-mounted reactor generates a larger amount of heat than a reactor used for a typical electronic component. For this reason, this reactor is normally used while being fixed to a setting object, such as a cooling base, to cool the coil and so on that generate heat when electricity is supplied.

When the portion of the magnetic core covering the outer peripheral surface of the coil (couple core portion) is formed of a hardened molded body from a magnetic material and resin, as disclosed in PTL 1, the resin, which generally has a thermal conductivity lower than that of a magnetic material such as iron, is interposed between the coil and the setting object. For this reason, it is difficult to dissipate heat from the coil serving as a heat generator. Hence, there is a demand to develop a structure that provides high heat dissipation performance even when the above-described hardened molded body is used.

The present invention has been made in view of the above circumstances, and one object of the invention is to provide a reactor having high heat dissipation performance.

Another object of the present invention is to provide a convertor including the above reactor and a power conversion device including the converter.

### Solution to Problem

The present invention achieves the above objects by forming, in a part of an outer peripheral surface of a coil or the like that generates heat, a portion that is not covered with a hardened molded body and providing a heat dissipation layer with high heat dissipation performance in this portion.

A reactor according to the present invention includes a coil formed by winding a wire, and a magnetic core in which a closed magnetic path is formed by both an inner core portion inserted in the coil and an outer core portion covering outer peripheral surfaces of the inner core portion and the coil. The outer core portion is formed of a mixture containing a magnetic material and resin. One of the coil and the inner core portion has an exposed portion where a part of the outer peripheral surface is not covered with the outer core portion, and at least a part of the exposed portion is in contact with a heat dissipation layer provided in a heat dissipation plate.

According to the above configuration, in the coil and the inner core portion whose temperatures become high when electricity is supplied, a part of the outer peripheral surface is not covered with the outer core portion, but is exposed. Hence, the exposed portion can be directly joined to the heat dissipation layer, and this allows heat of the coil and the inner core portion to be efficiently transmitted to the heat dissipation layer. Accordingly, the heat can be transmitted to a setting object, such as a cooling base, via the heat dissipation layer, and this enhances heat dissipation performance.

When the heat dissipation plate is provided, the exposed coil or inner core portion can be protected from external environments such as dust and corrosion, and mechanical characteristics, such as strength, can be ensured.

Since the reactor includes the heat dissipation layer, heat can be efficiently dissipated from a mount surface of the coil or the inner core portion via the heat dissipation layer. Therefore, the outer core portion can be formed by a hardened molded body composed of a magnetic material and resin. By being formed by the hardened molded body, the outer core portion can be more easily formed in a desired shape than when it is formed by a laminated body of electromagnetic steel sheets or a compact. Further, a part of an outer peripheral surface of a coil of an arbitrary shape can be easily covered with the outer core portion. Still further, since the mixture ratio of the magnetic material and resin can be easily changed, an outer core portion having desired magnetic characteristics (mainly, inductance) and a magnetic core including this outer core portion can be formed easily.

In an aspect of the present invention, at least a surface of the heat dissipation layer in contact with the exposed portion is formed of an insulating adhesive.

Since at least the surface of the heat dissipation layer in contact with the exposed portion is formed of an insulating adhesive, even when the heat dissipation plate is formed of a conductive material, the coil and the heat dissipation plate can be reliably isolated by contacting the coil with the heat dissipation layer. Therefore, the heat dissipation layer can be thinned, the heat can be easily transmitted to the setting object, and the reactor has high heat dissipation performance. By thinning the heat dissipation layer as described above, the gap between the mount surface of the coil or the inner core portion and an inner surface of the heat dissipation plate can be decreased, and this does substantially not cause an increase in size of the reactor. Further, by curing this adhesive, the coil or the inner core portion can be reliably joined to the heat dissipation layer. In this respect, it is also possible to obtain a reactor having high heat dissipation performance.

In an aspect of the present invention, at least a part of the heat dissipation layer is formed of a highly thermal conductive insulating adhesive, and at least a part of the exposed portion is joined to the highly thermal conductive insulating adhesive.

Since at least a part of the heat dissipation layer provided in the heat dissipation plate is formed of a highly thermal conductive insulating adhesive, even when the heat dissipation plate is formed of a conductive material, the coil and the heat dissipation plate can be reliably isolated by contacting (joining) the coil with the heat dissipation layer (highly thermal conductive insulating adhesive). Therefore, the heat dissipation layer can be thinned, the heat can be easily transmitted to the setting object, and the reactor has high heat dissipation performance. By thinning the heat dissipation layer as described above, the gap between the mount surface of the coil or the inner core portion and the inner surface of the heat dissipation plate can be decreased, and this does substantially not cause an increase in size of the reactor.

In an aspect of the present invention, the outer core portion is formed of a mixture of a magnetic material and resin.

By forming the outer core portion of the mixture of the magnetic material and resin, the mixture ratio of the magnetic material and resin can be easily changed. Hence, the reactor can include an outer core portion having desired magnetic characteristics. Here, the words “formed of a mixture of a magnetic material and resin” mean that the outer core portion is formed of a mixture composed of only the magnetic material and resin.

In an aspect of the present invention, the exposed portion is provided on a part of the outer peripheral surface of the coil.

By forming the exposed portion on the outer peripheral surface of the coil, heat from the coil serving as the heat generator can be efficiently transmitted to the heat dissipation layer, and the heat of the coil can be transmitted to the setting object via the heat dissipation layer. This provides high heat dissipation performance.

In an aspect of the present invention, the exposed portion is continuously formed from one end to the other end in an axial direction of the coil.

By continuously forming the exposed portion from one end to the other end in the axial direction of the coil on the outer peripheral surface of the coil, heat can be uniformly dissipated in the axial direction of the coil.

In an aspect of the present invention, the outer core portion is formed by transfer molding or injection molding.

In the reactor having the outer core portion formed by transfer molding or injection molding, the outer core portion can protect the coil and the inner core portion from external environments such as dust and corrosion, and can ensure mechanical characteristics such as strength. Hence, it is unnecessary to provide another component covering a side surface of the outer core portion, and therefore, it is unnecessary to provide another side wall portion that is combined with the heat dissipation plate to form a case. That is, a portion of the outer peripheral surface of the outer core portion except for the contact surface with the heat dissipation plate can serve as a side wall of the case. Since there is no need to provide a side wall portion, the number of components can be reduced, and the size of the reactor can be reduced.

In an aspect of the present invention, the reactor further includes a side wall portion that is provided separately from the heat dissipation plate to surround the coil and the magnetic core. A case that covers a side surface and a mount surface of the outer core portion is formed by combining the side wall portion and the heat dissipation plate.

By covering the side surface of the outer core portion, the outer core portion can be protected from external environments such as dust and corrosion, and mechanical characteristics, such as strength, can be ensured. Since the heat dissipation plate and the side wall portion that constitute the case are separately provided in the above structure, they can be separately produced, and the degree of freedom in production manner is high. Therefore, the heat dissipation plate and the side wall portion can be formed of different materials. Further, since the side wall portion and the heat dissipation plate can be combined after an assembly of the coil and the magnetic core is set on the heat dissipation plate, assembly efficiency of the reactor is high.

Since the case is included, in a step of forming the outer core portion, the outer core portion can be formed and the reactor can be obtained by first putting the assembly of the coil and the inner core portion in the case composed of the heat dissipation plate and the side wall portion provided integrally, pouring a mixture containing a magnetic material and resin, which form the outer core portion, into the case, molding the mixture in a desired shape, and curing the resin.

In an aspect of the present invention, the reactor includes a case having a side wall portion that is provided integrally with the heat dissipation plate. The case covers a side surface and a mount surface of the outer core portion.

In this structure, since the heat dissipation plate and the side wall portion that constitute the case are integrally formed, an assembly step for the heat dissipation plate and the side wall portion can be eliminated.

The reactor according to the present invention can be suitably used for a component of a converter. A converter according to the present invention includes a switching element, a driving circuit that controls operation of the switching element, and a reactor that smoothes a switching operation, and converts an input voltage through the operation of the switching element. The above-described reactor can serve as the reactor of the present invention. The converter of the present invention can be suitably used for a component of a power conversion device. A power conversion device according to the present invention includes a converter that converts an input voltage, and an inverter connected to the converter to mutually convert a direct current and an alternating current, and drives a load by power converted by the inverter. The above-described converter can serve as the converter of the present invention.

Since the converter of the present invention and the power conversion device of the present invention include the reactor of the present invention having high heat dissipation performance, they can be suitably used for, for example, a vehicle-mounted component that is required to have high heat dissipation performance.

### Advantageous Effects of Invention

The reactor of the present invention has high heat dissipation performance.

### BRIEF DESCRIPTION OF DRAWINGS

FIG. 1A is a schematic perspective view of a reactor according to a first embodiment.

FIG. 1B is a cross-sectional view taken along line B-B of FIG. 1A.

FIG. 2 is an exploded perspective view schematically illustrating a reactor according to a second embodiment.

FIG. 3 is a schematic configuration view of a power supply system in a hybrid vehicle.

FIG. 4 is a schematic circuit diagram illustrating an example of a power conversion device of the present invention including a converter of the present invention.

### DESCRIPTION OF EMBODIMENTS

Reactors according to embodiments will be described below with reference to the drawings. In the drawings, the same reference numerals denote the same members.

### First Embodiment

### <<Overall Configuration of Reactor>>

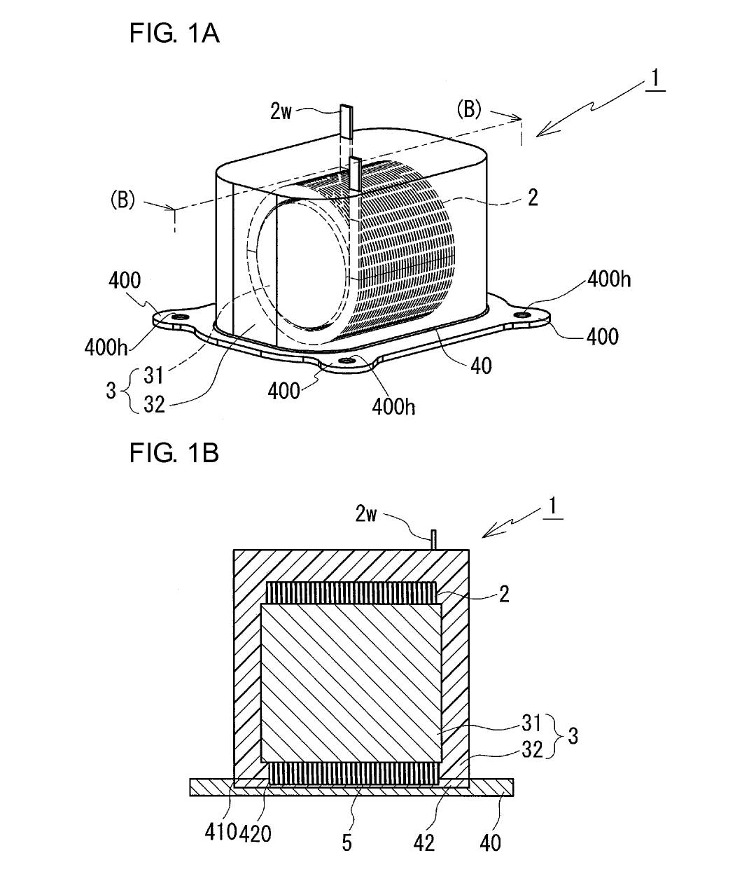

A first embodiment of the present invention will be described with reference to FIGS. 1A and 1B. A reactor 1 includes a coil 2 formed by winding a wire 2w, and a magnetic core 3 in which a closed magnetic path is formed by both an inner core portion 31 inserted in the coil 2 and an outer core portion 32 covering outer peripheral surfaces of the inner core portion 31 and the coil 2. The reactor of the present invention is characterized in that one of the coil 2 and the inner core portion 31 includes an exposed portion 5 where a part of the outer peripheral surface thereof is not covered with the outer core portion 32 and in that at least a part of the exposed portion 5 is in contact with a heat dissipation layer 42 of a heat dissipation plate 40. In the first embodiment, the exposed portion 5 is provided on the outer peripheral surface of the coil 2. The components will be described in detail below.

### [Coil]

The coil 2 is a cylindrical body formed by helically winding a single continuous wire 2w. Preferably, the wire 2w is a coated wire in which an insulating coating formed of an insulating material is provided on an outer periphery of a conductor formed of a conductive material such as copper, aluminum, or an alloy of these materials. Here, the conductor is formed by a rectangular copper wire, and the insulating coating is formed by a coated rectangular wire of enamel (representatively, polyamideimide). The thickness of the insulating coating is preferably within the range of 20 to 100 μm. The lamination factor can be increased as the thickness decreases, and the number of pin holes can be decreased and electric insulation can be improved as the thickness increases. For example, when the insulating coating is formed by applying an enamel material in a plurality of layers, the thickness of the insulating coating can be increased. Alternatively, the insulating coating can have a multilayered structure composed of different materials. For example, the insulating coating can have a multilayered structure in which a polyphenylenesulfide layer is provided on an outer periphery of a polyamideimide layer. The insulating coating having the multilayered structure is also excellent in electric insulation. The number of turns of the wire 2w can be selected appropriately. The coil 2 is formed by winding the coated rectangular wire in an edge-wise winding manner. By making an end-face shape of the coil 2 circular, the coil can be comparatively easily formed even by edge-wise winding. Instead of the wire 2w including the conductor formed by the rectangular wire, wires of various shapes, such as wires having a circular cross section and a polygonal cross section, can be used. A coil having a high lamination factor can be more easily formed by using a rectangular wire than using a round wire having a circular cross section. The coil can be various end-face shapes, such as an elliptical shape or a track shape, instead of the circular shape. Further, the coil may have a structure in which a pair of coil elements are arranged side by side such that axial directions thereof are parallel to each other.

Both ends of the wire 2w that forms the coil 2 are appropriately extended from the turns and are drawn to the outside of a below-described outer core portion 32. Terminal members (not illustrated) formed of a conductive material, such as copper or aluminum, are connected to conductor portions of the wire 2w that are exposed by stripping off the insulating coating. Via the terminal members, an external apparatus (not illustrated), such as a power supply for supplying electric power to the coil 2, is connected. The conductor portions of the wire 2w and the terminal members can be connected by welding such as TIG welding, or connection using pressure bonding or soldering. While both ends of the wire 2w are drawn upward to be orthogonal to the axial direction of the coil 2 in the example illustrated in FIGS. 1A and 1B, the drawing direction can be selected appropriately. Both ends of the wire may be drawn out to be parallel to the axial direction of the coil, or may be drawn out in different directions.

The coil 2 is joined to a heat dissipation layer 42 provided in a below-described heat dissipation plate 40 in a state in which a part of a below-described magnetic core 3 (inner core portion 31) is inserted in an inner periphery of the coil 2. The reactor 1 of this embodiment adopts a horizontal arrangement in which the coil 2 is joined to the heat dissipation layer 42 so that the axial direction of the coil 2 is parallel to a surface of a setting object, such as a cooling base, when the reactor 1 is set on the setting object. The coil 2 has an exposed portion 5 where a part of the outer peripheral surface of the coil 2 is not covered with the outer core portion 32.

### (Exposed Portion)

The exposed portion 5 is a portion of the outer peripheral surface of any one of the coil 2 and the inner core portion 31 that is not covered with the outer core portion 32, but is exposed. Since at least a part of the exposed portion 5 is directly joined to the heat dissipation layer 42, heat of the coil 2 and the inner core portion 31 can be efficiently transmitted to the heat dissipation layer 42. Hence, the heat can be transmitted to the setting object, such as the cooling base, via the heat dissipation layer 42, and this can enhance heat dissipation performance. Since the coil 2 generates heat when electricity is applied thereto, heat dissipation can be effectively performed particularly when the coil 2 is in contact with the heat dissipation layer 42. Here, as illustrated in FIG. 1B, the exposed portion 5 is continuously formed from one end to the other end in the axial direction of the coil 2. In the exposed portion 5, the coil 2 and the heat dissipation layer 42 are joined to each other.

### [Magnetic Core]

The magnetic core 3 includes a cylindrical inner core portion 31 inserted in the coil 2, and an outer core portion 32 provided to cover both end faces of the inner core portion 31 and a part of the cylindrical outer peripheral surface of the coil 2. The inner core portion 31 and the outer core portion 32 form a closed magnetic path when the coil 2 is excited. In the magnetic core 3, the inner core portion 31 and the outer core portion 32 can be given different magnetic characteristic by being formed of different materials. The saturation magnetic flux density of the inner core portion 31 can be higher than that of the outer core portion 32, and the relative permeability of the outer core portion 32 can be lower than that of the inner core portion 31.

The total relative permeability of the magnetic core 3 is preferably within the range of 10 to 50. This allows the inductance of the reactor 1 to be adjusted easily. Here, the total relative permeability of the magnetic core 3 refers to the sum of relative permeabilities of the inner core portion 31, the outer core portion 32, and a gap member when the gap member is provided in the magnetic core 3, for example, between the inner core portion 31 and the outer core portion 32, and refers to the sum of relative permeabilities of the inner core portion 31 and the outer core portion 32 when the gap member is not provided in the magnetic core 3.

Preferably, the relative permeability of the inner core portion 31 is within the range of 5 to 500, and the relative permeability of the outer core portion 32 is within the range of 5 to 50. Preferably, the relative permeability of the inner core portion 31 is within the range of 50 to 500 when the inner core portion 31 is formed by a compact, and within the range of 5 to 50 when the inner core portion 31 is formed by a mixture containing a magnetic material and resin.

It is assumed that the relative permeabilities of the above core portions are found as follows. First, the same material as the material of each of the core portions is worked to form a ring-shaped specimen that is 34 mm in outer diameter, 20 mm in inner diameter, and 5 mm in thickness. A wire is wound around the ring-shaped specimen to form 300 turns on a primary side and 20 turns on a secondary side, and a B-H initial magnetization curve of the specimen is measured within an H range of 0 to 100 oesteds (Oe). For measurement, a BH curve tracer “BHS-40S10K” manufactured by Riken Denshi Co., Ltd. can be used. The largest value of the gradient (B/H) of the obtained B-H initial magnetization curve is the relative permeability of the specimen, and the relative permeability is regarded as the relative permeability of the core portion. Here, the magnetization curve refers to a so-called DC magnetization curve. While the saturation magnetic flux density of the core portion will be described below, it refers to a magnetic flux density of the specimen obtained when a magnetic field of 10000 (Oe) is applied to the specimen by an electromagnet to achieve sufficient magnetic saturation.

### (Inner Core Portion)

The inner core portion 31 is a solid body having a columnar outer shape that follows the shape of an inner peripheral surface of the coil 2, is entirely formed by a compact, and does not include a gap member, an air gap, and an adhesive.

Typically, a compact is obtained by molding soft magnetic powder having an insulating coating on its surface and then baking the molded powder at a temperature lower than or equal to the heat-resistant temperature of the insulating coating. Mixed powder in which a binder is appropriately added to the soft magnetic powder can be used, or powder including silicone resin as the insulating coating can be used. The saturation magnetic flux density of the compact can be changed by adjusting the material of the soft magnetic powder, the mixture ratio of the soft magnetic powder and the binder, and the amounts of various coatings. A compact having high saturation magnetic flux density can be obtained by using soft magnetic powder having high saturation magnetic flux density or by reducing the amount of mixed binder to increase the proportion of the soft magnetic material. Moreover, the saturation magnetic flux density tends to be increased by increasing the molding pressure. Preferably, the material of the soft magnetic powder is selected and the molding pressure is adjusted so as to obtain a desired saturation magnetic flux density.

The soft magnetic powder can be powder of an iron group metal such as Fe, Co, or Ni, powder of an Fe-based alloy such as Fe—Si, Fe—Ni, Fe—Al, Fe—Co, Fe—Cr, or Fe—Si—Al, powder of rare-earth metal, or powder of an amorphous magnetic material. In particular, a compact having high saturation magnetic flux density can be easily formed of powder of an Fe-based alloy. Such powder can be produced, for example, by a gas atomization method, a water atomization method, or a mechanical pulverization method. When powder formed of a nanocrystalline material containing nano-sized crystals, preferably, powder formed of an anisotropic nanocrystalline material is used, a compact having high anisotropy and low coercivity can be obtained. The insulating coating provided on the soft magnetic powder is formed of, for example, a phosphate compound, a silicon compound, a zirconium compound, an aluminum compound, or a boron compound. The binder is formed of, for example, thermoplastic resin, non-thermoplastic resin, or higher fatty acid. This binder is eliminated or turned into an insulator, such as silica, by the above-described baking operation. Since an insulator, such as the insulating coating, exists on the surface of the soft magnetic powder in the compact, soft magnetic particles are isolated from one another. As a result, eddy-current loss can be reduced. Even when a high-frequency current is supplied to the coil, the loss can be reduced. As the compact, a known type of compact can be used.

The content of the soft magnetic powder (magnetic component) in the compact is preferably more than or equal to 70 volume % when the volume of the compact is 100 volume %, and more preferably more than or equal to 80 volume %. Since the amount of magnetic component in the compact is predominantly larger than that of an insulating component, the inner core portion 31 can be formed of a magnetic material having high relative permeability and high saturation magnetic flux density. Preferably, the inner core portion 31 has a relative permeability within the range of 50 to 500, and a saturation magnetic flux density higher than or equal to 1.0 T. Further, the thermal conductivity of the inner core portion 31 is preferably higher than or equal to 10 W/m·K.

Instead of the above-described compact, the inner core portion 31 can be formed by a mixture (hardened molded body) containing a magnetic material and resin similar to those in a below-described outer core portion 32 or a laminated body of electromagnetic steel sheets represented by silicon steel sheets. The cross-sectional shape of the inner core portion 31 follows the shape of the inner peripheral surface of the coil 2, and various shapes, such as an elliptical shape, a track shape, or a polygonal shape, can be used instead of the circular shape.

In the example illustrated in FIGS. 1A and 1B, the length of the inner core portion 31 is slightly longer than the length of the coil 2. Here, the term “length” refers to a length in the axial direction of the coil 2. For this reason, both end faces of the inner core portion 31 and vicinities thereof protrude from end faces of the coil 2. The protruding length of the inner core portion can be selected appropriately. While the inner core portion 31 protrudes from the end faces of the coil 2 by the same protruding length here, it may protrude by different protruding lengths, or the inner core portion 31 may protrude from only one of the end faces of the coil 2. Alternatively, the length of the inner core portion and the length of the coil may be equal, or the length of the inner core portion may be shorter than the length of the coil. In any case, the outer core portion 32 is provided to form a closed magnetic path when the coil 2 is excited.

### (Outer Core Portion)

The outer core portion 32 is provided to cover substantially all of both end faces of the coil 2 and portions of the outer peripheral surface of the coil 2 that are not in contact with a below-described heat dissipation layer 42, and both end faces and their vicinities of the inner core portion 31. In the magnetic core 3, the outer core portion 32 and the inner core portion 31 form a closed magnetic path. The outer core portion 32 and the inner core portion 31 may be joined to each other without using an adhesive or a gap member, but with the component resin of the outer core portion 32, or may be joined with an adhesive or a gap member being disposed between the outer core portion 32 and the end faces of the inner core portion 31. Here, the former structure is adopted. Therefore, the magnetic core 3 is an integrated body that is integrally formed as a whole without using an adhesive or a gap member. When the latter structure is adopted, the gap member is formed of a nonmagnetic material (for example, alumina, glass epoxy resin, or unsaturated polyester), or the gap is an air gap.

The outer core portion 32 covers substantially all of the portions of the coil 2 that are not in contact with the heat dissipation layer 42. Therefore, in the reactor 1, for example, the outer core portion 32 can protect the coil 2 and the inner core portion 31 from external environments such as dust and corrosion, and can ensure mechanical characteristics such as strength.

The outer core portion 32 is entirely formed by a mixture (hardened molded body) containing a magnetic material and resin. Typically, a hardened molded body can be formed by transfer molding, injection molding, MIM (Metal Injection Molding), cast molding, or press molding using magnetic powder and hard resin powder. In transfer molding, injection molding, and MIM, normally, powder formed of a magnetic material (mixed powder that further includes nonmagnetic powder as required) and fluid binder resin are mixed to form a fluid mixture, the fluid mixture is injected into a mold with a predetermined pressure and is molded, and the binder resin is cured. In cast molding, the fluid mixture is injected into a mold without any pressure, is molded, and cured. In any of the molding methods, magnetic powder similar to the above-described soft magnetic powder used for the inner core portion 31 can be used. In particular, an iron-based material, such as pure iron powder or iron-based alloy powder, can be preferably used as the soft magnetic powder for the outer core portion 32. Coated powder in which surfaces of particles of a soft magnetic material are covered with a coating of phosphate may be used. As the magnetic powder, powder having an average particle diameter within the range of 1 to 1000 μm, preferably, within the range of 10 to 500 μm is easy to use.

In any of the above-described molding methods, thermosetting resin, such as epoxy resin, phenol resin, or silicone resin, can be suitably used as the binder resin. When thermosetting resin is used, the resin is thermally set by heating a molded body. As the binder resin, room-temperature setting resin or low-temperature setting resin may be used. In this case, the resin is set at a room temperature or a comparatively low setting temperature. Since a comparatively large amount of resin of a nonmagnetic material remains in a hardened molded body, even when the same soft magnetic powder as that for the compact included in the inner core portion 31 is used, it is easy to form a core whose saturation magnetic flux density and relative permeability are lower than those of the compact.

The material of the hardened molded body may further include a filler formed of a ceramic material, such as alumina or silica, in addition to the powder of the magnetic material and the binder resin. By mixing the filler that has a lower specific gravity than the powder of the magnetic material, nonuniform dispersion of the magnetic powder is suppressed. Thus, it is easy to obtain an outer core portion in which magnetic powder is uniformly dispersed as a whole. When the filler is formed of a material having high thermal conductivity, this can enhance heat dissipation performance.

When the filler is mixed, the total content of the magnetic material powder and the filler is set within the range of 20 to 70 volume % when the volume of the outer core portion is 100%. The hardened molded body may, of course, be formed of a mixture composed of only a magnetic material and resin.

When transfer molding or injection molding described above is used, the relative permeability and saturation magnetic flux density of the outer core portion can be adjusted by changing the ratio of the magnetic material powder and the binder resin and, when a filler is included, by changing the ratio of the magnetic material powder, the binder resin, and the filler. For example, the relative permeability tends to decrease as the proportion of the magnetic material powder decreases. Preferably, the relative permeability and saturation magnetic flux density of the outer core portion are adjusted so that the reactor has a desired inductance. The relative permeability of the outer core portion 32 is preferably within the range of 5 to 50, and the saturation magnetic flux density of the outer core portion 32 is preferably higher than or equal to 0.6 T, more preferably, higher than or equal to 0.8 T. The thermal conductivity of the outer core portion 32 is preferably higher than or equal to 0.25 W/m·K.

### [Heat Dissipation Plate]

The heat dissipation plate 40 is a substantially rectangular plate, and is fixed in contact with a setting object such as a cooling base. While the heat dissipation plate 40 is located at a lower position in a setting state of the example illustrated in FIGS. 1A and 1B, it can be located at an upper position or at a side position. A heat dissipation layer 42 is provided in one surface of the heat dissipation plate 40 on which an assembly of the coil 2 and the magnetic core 3 is set. The outer shape of the heat dissipation plate 40 can be selected appropriately. Here, the heat dissipation plate 40 includes attachment portions 400 projecting from four corners, and bolt holes 400h in which bolts (not illustrated) for fixing to the setting object, such as the cooling base, are to be inserted. The bolt holes 400h can be formed by any of unthreaded through holes and threaded screw holes, and the number of bolt holes 400h can be selected appropriately.

When the heat dissipation plate 40 is formed of a metal material, it can have high heat dissipation performance because the metal material generally has high thermal conductivity. As the metal material of the heat dissipation plate 40, for example, aluminum or an alloy thereof, magnesium (thermal conductivity: 156 W/m·K) or an alloy thereof, copper (398 W/m·K) or an alloy thereof, silver (427 W/m·K) or an alloy thereof, iron, or austenite stainless steel (for example, SUS 304: 16.7 W/m·K) can be used. The use of aluminum, magnesium, or an alloy thereof described above can contribute to weight reduction of the reactor. In particular, aluminum or an alloy thereof can be suitably used for a vehicle-mounted component because it is also highly corrosion-resistant. When the heat dissipation plate 40 is formed of the metal material, it can be formed not only by casting such as die casting, but also by plastic forming such as press working. Here, the heat dissipation plate 40 is formed of aluminum.

### [Heat Dissipation Layer]

The heat dissipation layer 42 can be formed of a material having high thermal conductivity. Preferably, the thermal conductivity of the heat dissipation layer 42 is 0.5 W/m·K or more, and the heat dissipation layer 42 has an electric insulation property. The thermal conductivity of the heat dissipation layer 42 is preferably as high as possible, and the heat dissipation layer 42 is formed of a material having a thermal conductivity that is preferably 2 W/m·k or more, 3 W/m·k or more, particularly 10 W/m·K or more, more particularly 20 W/m·K or more, and most particularly 30 W/m·K or more.

The material having high thermal conductivity includes a nonmetal inorganic material such as a ceramic material. As the ceramic material, one material selected from an oxide containing at least one of a metal element, B, and Si, a carbide containing at least one of a metal element, B, and Si, and a nitride containing at least one of a metal element, B, and Si can be used. Examples of the ceramic material are silicon nitride (Si₃N₄): about 20 to 150 W/m·K, alumina (Al₂O₃): about 20 to 30 W/m·K, aluminum nitride (AlN): about 200 to 250 W/m·K, boron nitride (BN): about 50 to 65 W/m·K, and silicon carbide (SiC): about 50 to 130 W/m·K. These ceramics materials are excellent not only in heat dissipation performance but also in electric insulation. In the case of formation using the above ceramic material, evaporation, such as PVD or CVD, can be utilized. Alternatively, a sintered plate of the ceramic material can be prepared and formed with an appropriate adhesive.

Alternatively, the above material can be an insulating resin containing a filler formed of the above ceramic material. For example, the insulating resin is epoxy resin or acrylic resin. When the insulating resin contains the filler that is excellent in heat dissipation performance and electric insulation, the heat dissipation layer 42 can be formed to be excellent in heat dissipation performance and electric insulation. Even when the resin containing the filler is used, the heat dissipation layer 42 can be easily formed, for example, by applying the resin on the heat dissipation plate 40. When the heat dissipation layer 42 is formed of the insulating resin, it can be easily formed by screen printing.

The heat dissipation layer 42 can also be formed of an adhesive. The adhesive is preferably an insulating adhesive, and more preferably a highly thermal conductive insulating adhesive. By forming the heat dissipation layer 42 of an adhesive, adhesion of the assembly of the coil 2 and the magnetic core 3, particularly, the exposed portion 5, where the coil 2 is exposed, to the heat dissipation layer 42 can be increased. In particular, the insulating adhesive can enhance insulation between the exposed portion 5 of the coil 2 and the heat dissipation layer 42, and the highly thermal conductive insulating adhesive can enhance not only insulation but also thermal conductivity. For example, the insulating adhesive is an epoxy resin adhesive or an acrylic resin adhesive. For example, the highly thermal conductive insulating adhesive is the insulating adhesive containing a filler formed of the above-described ceramic material. The thermal conductivity of the highly thermal conductive adhesive is higher than 2 W/m·K.

The heat dissipation layer 42 may have a multilayered structure. In this case, a layer on a front side of the heat dissipation layer 42 in contact with the assembly of the coil 2 and the magnetic core 3 (a front side in contact with the exposed portion 5) can be formed of the above-described insulating material, and a layer in contact with the heat dissipation plate 40 can be formed of the above-described material having high thermal conductivity. Alternatively, the front side may be formed of the insulating adhesive or the highly thermal conductive adhesive described above, and the side in contact with the heat dissipation plate 40 may be formed of the above-described material having high thermal conductivity. Even when the heat dissipation layer 42 has such a multilayered structure, it is preferable that the total thermal conductivity of the heat dissipation layer 42 should be as high as possible, that is, 0.5 W/m˜K or more, 2 W/m·K or more, 3 W/m·K or more, particularly 10 W/m·K or more, more particularly 20 W/m·K or more, and most particularly 30 W/m·K or more.

Here, the heat dissipation layer 42 is formed of an epoxy adhesive containing a filler of alumina (thermal conductivity: 3 W/m·K). The heat dissipation layer 42 can have any shape as long as the joint surface to the assembly of the coil 2 and the magnetic core 3 has an area that allows sufficient contact with the heat dissipation layer 42.

The heat dissipation layer 42 preferably has, on the joint surface to the exposed portion 5, a positioning portion for positioning the exposed member (here, the coil 2). By forming the positioning portion, the assembly of the coil 2 and the inner core portion 31 can be easily positioned and fixed to the heat radiation layer 42 when the outer core portion 32 is formed after the assembly is joined to the heat dissipation layer 42. Here, as illustrated in FIG. 1B, a positioning groove 420 shaped to follow the shape of the coil 2 is provided on the heat dissipation layer 42. Here, the positioning groove 420 is a groove that has an arc-shaped cross section and has a length in the axial direction of the coil 2. By placing the coil 2 in the positioning groove 420, the outer core portion 32 is not formed on a contact surface of the coil 2 with the positioning groove 420, but the exposed portion 5 is formed on the coil 2. The manner of the positioning portion is not particularly limited to the positioning groove 420, and the positioning portion can be formed in any manner as long as it can position the coil 2 on the heat dissipation layer 42.

### [Other Components]

### (Insulator)

To further increase insulation between the coil 2 and the magnetic core 3, an insulator is preferably provided at a portion of the coil 2 in contact with the magnetic core 3. To provide the insulator, for example, insulating tape can be stuck on inner and outer peripheral surfaces of the coil 2, or insulating paper or insulating sheets can be provided thereon. Alternatively, a bobbin (not illustrated) formed of an insulating material may be provided on an outer periphery of the inner core portion 31. The bobbin can be a cylindrical body covering the outer periphery of the inner core portion 31. When a bobbin having annular flange portions extending in a circumferential direction from both ends of the cylindrical body is used, insulation between the end faces of the coil 2 and the outer core portion 32 can be increased. As the material of the bobbin, an insulating resin, such as polyphenylene sulfide (PPS) resin, a liquid crystal polymer (LCP), or polytetrafluoroethylene (PTFE) resin, can be used suitably.

### <<Manufacturing Method for Reactor>>

The reactor 1 having the above-described configuration can be manufactured as follows. Components will be described with appropriate reference to FIGS. 1A and 1B. First, a coil 2 and an inner core portion 31 formed by a compact are prepared, and the inner core portion 31 is inserted in the coil 2 to form an assembly of the coil 2 and the inner core portion 31. In this case, an insulator may be appropriately provided between the coil 2 and the inner core portion 31, as described above.

Next, the assembly is joined to a heat dissipation layer 42 of a heat dissipation plate 40. In this case, by using a positioning groove 420 provided in the heat dissipation layer 42, a portion of the coil 2 to be exposed can be positioned to reliably contact with the heat dissipation layer 42, and the assembly can be easily joined to the heat dissipation layer 42.

Then, an outer core portion 32 is formed on an outer peripheral surface of the assembly joined to the heat dissipation layer 42. In this case, a plurality of molds (not illustrated) are used to form the outer core portion 32. Next, a container-shaped lower mold that can receive the heat dissipation plate 40 and has an opening on an upper side, and a container-shaped upper mold that is provided between an inner side wall surface of the lower mold and the assembly and has an opening on a lower side are prepared. A surface of the upper mold opposite from the opening has an injection port from which a material that forms the outer core portion is to be injected. In a state in which the assembly is set in these molds, a mixture containing a magnetic material and resin, which serves as the material of the outer core portion, is injected from the injection port provided in the upper mold. In this case, no gap is formed at joint faces of the lower mold, the upper mold, and the heat dissipation plate. After the injected mixture is hardened, the molds are withdrawn. In a reactor 1 thus obtained, an exposed portion 5 of the coil 2 is joined to the heat dissipation layer 42 of the heat dissipation plate 40, and the outer core portion 32 is formed on the outer periphery of the assembly composed of the coil 2 and the inner core portion 31 except for the exposed portion 5.

### <<Applications>>

The reactor 1 having the above-described configuration can be suitably applied, for example, under power supply conditions where the maximum current (direct current) is about 100 to 1000 A, the average voltage is about 100 to 1000 V, and the used frequency is about 5 to 100 kHz. Typically, the reactor 1 can be suitably used for a component of a vehicle-mounted power conversion device in an electric vehicle or a hybrid vehicle.

### <<Advantages>>

In the reactor 1 of the first embodiment, since the coil 2, which generates heat when electricity is supplied thereto, has the exposed portion 5 where a part of the coil 2 is exposed without being covered with the outer core portion 32, the exposed portion 5 can be joined to the heat dissipation layer 42, and heat of the coil 2 can be efficiently transmitted to the heat dissipation layer 42. Accordingly, heat of the coil 2 can be transmitted to the setting object, such as the cooling base, via the heat radiation layer 42, and this provides high heat dissipation performance. Further, since the heat dissipation layer 42 is formed of an adhesive, the coil 2 can be reliably joined to the heat dissipation layer 42 by curing the adhesive. The reactor 1 is also excellent in heat dissipation performance in this respect.

Since the reactor 1 does not include a case, size reduction thereof can be achieved. Even when the reactor 1 does not include a case, the outer core portion 32 can protect the coil 2 and the inner core portion 31 from external environments such as dust and corrosion, and can ensure mechanical characteristics such as strength. Also, the heat dissipation plate 40 can ensure mechanical characteristics of the coil 2 in the exposed portion 5.

### First Modification

In the above-described first embodiment, the outer core portion 32 is formed after the assembly of the coil 2 and the inner core portion 31 is joined to the heat dissipation layer 42. After an assembled body of the assembly of the coil 2 and the inner core portion 31 and the outer core portion 32 is formed, it can be joined to the heat dissipation layer 42.

The heat dissipation plate 40 preferably has, on the surface where the heat dissipation layer 42 is provided, a fixing groove 410 (see FIG. 1B) provided along the shape of the assembly of the coil 2 and the magnetic core 3. The heat dissipation layer 42 is provided in the fixing groove 410. When the assembly is joined to the heat dissipation layer 42, it can be easily positioned and can be restricted from being displaced because the fixing groove 410, in which the heat dissipation layer 42 is provided, has the shape that follows the shape of the assembly. In this case, it is unnecessary to form a positioning portion on the heat dissipation layer 42.

In this manner, the coil has an exposed portion, similarly to the first embodiment. Since the exposed portion is directly joined to the heat dissipation layer, high heat dissipation performance is obtained. Further, mechanical characteristics of the coil and the inner core portion can be ensured by the outer core portion and the heat dissipation plate. Hence, the case can be omitted, and the size of the reactor can be reduced.

### Second Embodiment

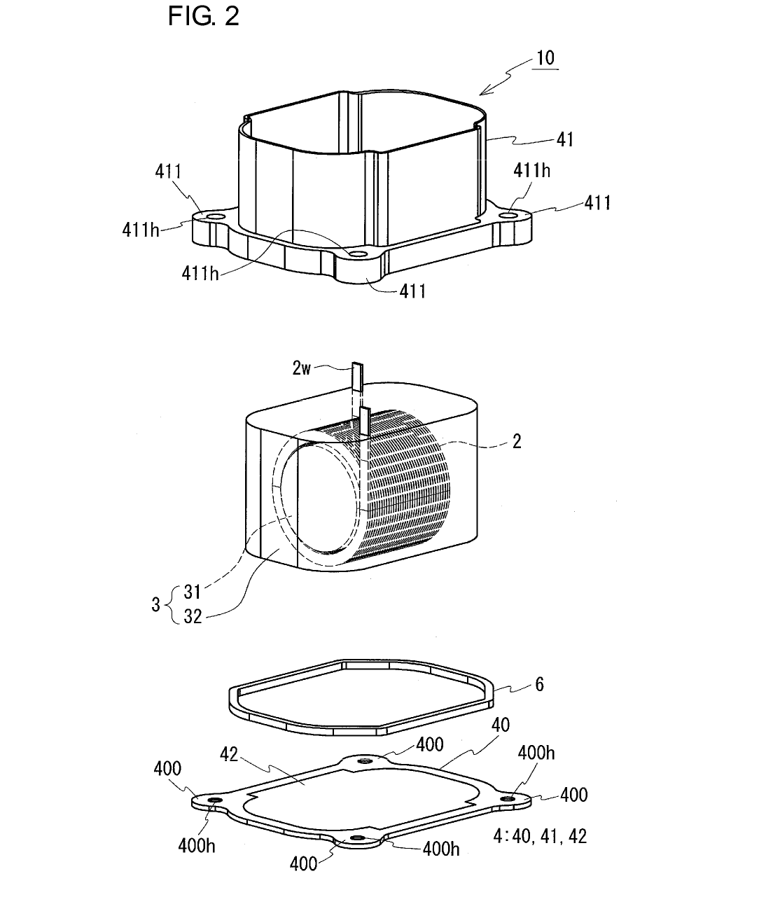

A reactor according to a second embodiment of the present invention will be described with reference to FIG. 2. The second embodiment is different from the above-described reactor 1 of the first embodiment in including a side wall portion 41 that covers a side surface of an outer core portion 32 and is combined with a heat dissipation plate 40 to form a case 4. Although the reactor 1 can be used as it is, when the side surface of the outer core portion 32 is covered with the side wall portion 41, mechanical characteristics of the outer core portion 32 can also be ensured. The following description will be given with a focus on this difference. Since other structures are similar to those adopted in the first embodiment, descriptions thereof are skipped.

### [Side Wall Portion]

The side wall portion 41 is provided separately from the heat dissipation plate 40. The side wall portion 41 and the heat dissipation plate 40 are combined with fixtures to form the case 4 that covers the side surface and a mount surface of the outer core portion 32. The side wall portion 41 is a rectangular frame body that is open at both ends. The side wall portion 41 is provided to surround the side surface of the outer core portion 32 when assembled with a lower opening being closed by the heat dissipation plate 40. An upper opening is not closed by any member, but is open. A joint area of the side wall portion 41 to the heat dissipation plate 40 has a rectangular shape that follows the outer shape of the heat dissipation plate 40, and an area on the upper opening side is curved such as to follow an outer peripheral surface of the outer core portion 32.

The joint area of the side wall portion 41 to the heat dissipation plate 40 has attachment portions 411 projecting from four corners, similarly to the heat dissipation plate 40. The attachment portions 411 are provided with bolt holes 411h to form attachment parts. The bolt holes 411h may be formed only of the material of the side wall portion 41, or formed by cylinders made of a different material. Here, metal pipes are provided to form the bolt holes 411h. Alternatively, the side wall portion 41 may have no attachment portion, and only the heat dissipation plate 40 may have attachment portions 400. In this manner, the outer shape of the heat dissipation plate 40 is formed so that the attachment portions 400 of the heat dissipation plate 40 protrude from the outer shape of the side wall portion 41.

The heat dissipation plate 40 and the side wall portion 41 can be integrally connected by various types of fixtures. The fixtures are joint members such as an adhesive and bolts. Here, the heat dissipation plate 40 and the side wall portion 41 are provided with the bolt holes (not illustrated), and are combined by screwing bolts (not illustrated) serving as the fixtures into the bolt holes.

When the material of the side wall portion 41 is a metal material, the case can have high heat dissipation performance because the metal material generally has high thermal conductivity. As the metal material, the same material as the above-described material of the heat dissipation plate 40 can be used. Alternatively, the material can be a nonmetal material. Examples of the nonmetal material are resins such as polybutylene terephthalate (PBT) resin, urethane resin, polyphenylene sulfide (PPS) resin, and acrylonitrile-butadiene-styrene (ABS) resin. Since these nonmetal materials are lighter than the above-described metal material, the weight of the case can be reduced even when it includes the case. When a filler of a ceramic material is mixed in the above resin, heat dissipation performance can be enhanced. When the case 4 is formed of resin, injection molding can be used suitably.

The heat dissipation plate 40 and the side wall portion 41 can be formed of the same kind of material. In this case, the heat dissipation plate 40 and the side wall portion 41 are equal in thermal conductivity. Alternatively, since the heat dissipation plate 40 and the side wall portion 41 are separately formed, they can be formed of different materials. In this case, when the materials thereof are selected particularly so that the thermal conductivity of the heat dissipation plate 40 is higher than that of the side wall portion 41, heat of an exposed portion 5 of a coil 2 provided on the heat dissipation plate 40 can be efficiently transmitted to a setting object such as a cooling base. Here, the heat dissipation plate 40 and the side wall portion 41 are both formed of aluminum. Alternatively, the heat dissipation plate 40 can be formed of aluminum, and the side wall portion 41 can be formed of PBT resin.

### <<Manufacturing Method for Case (Side Wall Portion)-Equipped Reactor>>

A reactor equipped with the above-described side wall portion 41 (hereinafter referred to as a case-equipped reactor 10) can be obtained by placing the side wall portion 41 from above to surround an assembly of a coil 2 and a magnetic core 3 and combining a heat dissipation plate 40 and the side wall portion 41 with fixtures (here, bolts separately prepared (not illustrated)).

The above-described method obtains the case-equipped reactor 10 through steps of forming the assembly of the coil 2 and the inner core portion 31, then joining the assembly to the heat dissipation plate 40, forming the outer core portion 32, and finally assembling the side wall portion 41. That is, the method assembles the side wall portion 41 in the reactor 1 of the first embodiment. Instead of this method, the case-equipped reactor 10 can be obtained through steps of forming the assembly of the coil 2 and the inner core portion 31, then joining the assembly to the heat dissipation plate 40, assembling the side wall portion 41, and finally forming the outer core portion 32. In this case, the assembly of the coil 2 and the inner core portion 31 is first fixed to the heat dissipation plate 40, and the side wall portion 41 is combined with the heat dissipation plate 40 to surround the assembly, so that the case 4 is formed. After a mixture containing a magnetic material and resin that forms the outer core portion 32 is poured into the case 4 and is molded in a predetermined shape, the resin is cured. According to this method, the outer core portion 32 can be formed, and the case-equipped reactor 10 can be obtained. Therefore, a costly mold is unnecessary when manufacturing the case-equipped reactor 10.

When the case 4 is filled with resin, a packing 6 is preferably provided to prevent uncured resin from leaking out from a gap between the heat dissipation plate 40 and the side wall portion 41. Here, the packing 6 is an annular body formed in correspondence to the shape and size of the joint portion between the side wall portion 41 and the heat dissipation plate 40, and is formed of synthetic rubber, but the packing 6 can be formed of an appropriate material. On a mount surface side of the side wall portion 41 of the case 4, a packing groove (not illustrated) in which the packing 6 to be set is provided.

Since the heat dissipation plate 40 and the side wall portion 41 are independent members, they may be combined after the assembly of the coil 2 and the inner core portion 31 is set on the heat dissipation plate 40. Alternatively, the heat dissipation plate 40 and the side wall portion 41 can be combined after an assembled body in which the outer core portion 32 is provided on an outer periphery surface of the assembly is set on the heat dissipation plate 40. Therefore, assembly performance of the reactor is high.

### Second Modification

While the heat dissipation plate 40 and the side wall portion 41 are separately provided and the case 4 is obtained by combining the heat dissipation plate 40 and the side wall portion 41 with fixtures in the above-described second embodiment, a case formed by integrally forming the heat dissipation plate 40 and the side wall portion 41 can be used. In this case, since the heat dissipation plate and the side wall portion are integrally formed of the same material, a step of assembling the heat dissipation plate and the side wall portion can be omitted.

### Third Embodiment

The above-described first and second embodiments adopt the horizontal arrangement in which the coil is joined to the heat dissipation layer so that the axial direction of the coil is parallel to the surface of the setting object, such as the cooling base, when the reactor is set on the setting object. Alternatively, it is possible to adopt a vertical arrangement in which the coil is joined to the heat dissipation layer 42 so that the axial direction of the coil is orthogonal to the surface of the setting object.

When an assembly of a coil and an inner core portion is set in the vertical arrangement, an outer core portion is provided to cover substantially all of end faces and an outer peripheral surface of the coil and an end face and an outer peripheral surface of the inner core portion that are not in contact with the heat dissipation plate. That is, an exposed portion that is exposed without being covered with the outer core portion is provided on one end face of the inner core portion. Since the exposed portion is directly joined to the heat dissipation layer, heat of the inner core portion can be transmitted to the heat dissipation layer, and heat of the inner core portion can be transmitted to a setting object, such as a cooling base, via the heat dissipation layer.

Even when a case is not provided, the outer core portion can protect the coil and the inner core portion from external environments such as dust and corrosion, and can ensure mechanical characteristics such as strength. The heat dissipation plate can ensure mechanical characteristics of the inner core portion in the exposed portion. A case (side wall portion) can be provided. In this case, the side wall portion may be provided separately from the heat dissipation plate, or may be molded integrally with the heat dissipation plate.

### Fourth Embodiment

The reactors according to the first to third embodiments and the first and second modifications can be used as a component of a converter mounted in a vehicle or the like and a component of a power conversion device including the converter.

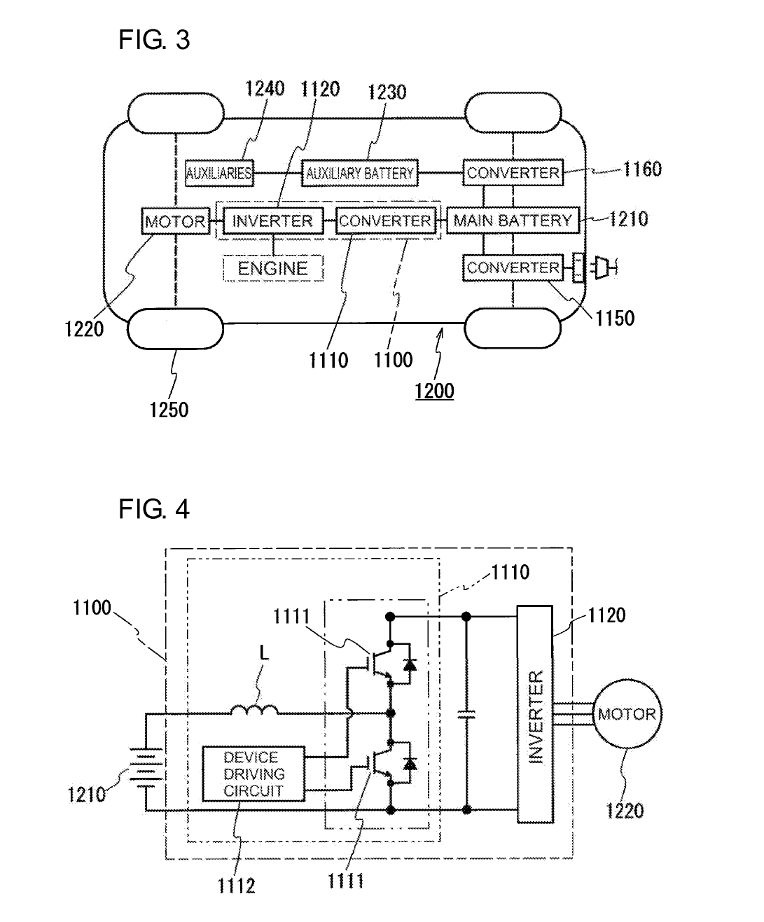

As illustrated in FIG. 3, a vehicle 1200, such as a hybrid vehicle or an electric vehicle, includes a main battery 1210, a power conversion device 1100 connected to the main battery 1210, and a motor (load) 1220 driven by power supplied from the main battery 1210 to be used for driving.

Typically, the motor 1220 is a three-phase alternating-current motor, drives wheels 1250 during driving and functions as a power generator during regeneration. In the case of a hybrid vehicle, the vehicle 1200 includes an engine in addition to the motor 1220. While an inlet is illustrated as a charge portion of the vehicle 1200 in FIG. 3, a plug may be provided.

The power conversion device 1100 includes a converter 1110 connected to the main battery 1210, and an inverter 1120 connected to the converter 1110 to mutually convert direct current and alternating current. In this embodiment, the converter 1110 increases a direct-current voltage (input voltage) of about 200 to 300 V from the main battery 1210 into about 400 to 700 V during driving of the vehicle 1200, and feeds power to the inverter 1120. Further, the converter 1110 decreases a direct-current voltage (input voltage) output from the motor 1220 via the inverter 1120 to a direct-current voltage adapted for the main battery 1210, and charges the main battery 1210 during regeneration. The inverter 1120 converts a direct current boosted by the converter 1110 into a predetermined alternating current, feeds power to the motor 1220 during driving of the vehicle 1200, and converts an alternating-current output from the motor 1220 into a direct current and outputs the direct current to the converter 1110 during regeneration.

As illustrated in FIG. 4, the converter 1110 includes a plurality of switching elements 1111, a driving circuit 1112 for controlling the operation of the switching elements 1111, and a reactor L, and converts (here, increases or decreases) the input voltage by repetition of ON/OFF (switching operation). As the switching elements 1111, power devices, such as FETs or IGBTs, are used. By utilizing the property of the coil that hinders the change of the current flowing into the circuit, the reactor L serves to smooth the change of increase and decrease of the current caused by the switching operation. As the reactor L, the reactor according to any of the first to third embodiments and the first and second modifications is used. By using a reactor having high heat dissipation performance, heat dissipation performance of the power conversion device 1100 (including the converter 1110) can be enhanced.

In addition to the converter 1110, the vehicle 1200 includes a feeding-device converter 1150 connected to the main battery 1210, and an auxiliaries power-supply converter 1160 connected to an auxiliary battery 1230 serving as a power supply for auxiliaries 1240 and the main battery 1210. The auxiliaries power-supply converter 1160 converts the voltage of the main battery 1210 from high voltage to low voltage. The converter 1110 typically performs DC-DC conversion, whereas the feeding-device converter 1150 and the auxiliaries power-supply converter 1160 perform AC-DC conversion. The feeding-device converter 1150 performs DC-DC conversion in some cases. As reactors of the feeding-device converter 1150 and the auxiliaries power-supply converter 1160, reactors that have structures similar to those of the reactors of the first to third embodiments and the first and second modifications and are appropriately made different in size and shape can be used. Alternatively, the reactors of the first to third embodiments to the first and second modifications can be used for a converter that converts input power by only increasing or can be used for a converter that converts input power by only decreasing the voltage.

The present invention is not limited to the above-described embodiments, and can be appropriately modified without departing from the scope of the invention.

### INDUSTRIAL APPLICABILITY

The reactor of the present invention can be used as a component of a power conversion device such as a vehicle-mounted converter mounted in a vehicle such as a hybrid vehicle, an electric vehicle, or a fuel-cell powered vehicle.

### REFERENCE SIGNS LIST

1: reactor 10: case-equipped reactor

2: coil 2w: wire

3: magnetic core 31: inner core portion 32: outer core portion

4: case 40: heat dissipation plate 41: side wall portion 42: heat dissipation layer

400, 411: attachment portion 400h, 411h: bolt hole

410: fixing groove 420: positioning groove

5: exposed portion

6: packing

1100: power conversion device 1110: converter

1111: switching element 1112: driving circuit

L: reactor 1120: inverter

1150: feeding-device converter 1160: auxiliaries power-supply converter

1200: vehicle 1210: main battery 1220: motor

1230: auxiliary battery 1240: auxiliaries 1250: wheel

1. A reactor comprising a coil formed by winding a wire, and a magnetic core in which a closed magnetic path is formed by both an inner core portion inserted in the coil and an outer core portion covering outer peripheral surfaces of the inner core portion and the coil,
wherein the outer core portion is formed of a mixture containing a magnetic material and resin, and
wherein one of the coil and the inner core portion has an exposed portion where a part of the outer peripheral surface is not covered with the outer core portion, and at least a part of the exposed portion is in contact with a heat dissipation layer provided in a heat dissipation plate.

2. The reactor according to claim 1, wherein at least a surface of the heat dissipation layer in contact with the exposed portion is formed of an insulating adhesive.

3. The reactor according to claim 1,
wherein at least a part of the heat dissipation layer is formed of a highly thermal conductive insulating adhesive, and
wherein at least a part of the exposed portion is joined to the highly thermal conductive insulating adhesive.

4. The reactor according to claim 1, wherein the outer core portion is formed of a mixture of a magnetic material and resin.

5. The reactor according to claim 1, wherein the exposed portion is provided on a part of the outer peripheral surface of the coil.

6. The reactor according to claim 5, wherein the exposed portion is continuously formed from one end to the other end in an axial direction of the coil.

7. The reactor according to claim 1, wherein the outer core portion is formed by transfer molding or injection molding.

8. The reactor according to claim 1, further comprising a side wall portion that is provided separately from the heat dissipation plate to surround the coil and the magnetic core,
wherein a case that covers a side surface and a mount surface of the outer core portion is formed by combining the side wall portion and the heat dissipation plate.

9. The reactor according to claim 1, further comprising a case having a side wall portion that is provided integrally with the heat dissipation plate,
wherein the case covers a side surface and a mount surface of the outer core portion.

10. A converter comprising a switching element, a driving circuit that controls operation of the switching element, and a reactor that smoothes a switching operation, the converter converting an input voltage through the operation of the switching element,
wherein the reactor is the reactor according to claim 1.

11. A power conversion device comprising a converter that converts an input voltage, and an inverter connected to the converter to mutually convert a direct current and an alternating current, the power conversion device driving a load by power converted by the inverter,
wherein the converter is the converter according to claim 10.
